(19) United States
(12) Patent Application Publication
(10) Pub. No.: US 2008/0168889 A1
(43) Pub. Date: Jul. 17, 2008

(54) Multi task drumstick

(76) Inventor: David Chappell Rundle, Campbellville (CA)

Correspondence Address: DAVID C RUNDLE, 2291 BRITANNIA RD, CAMPBELLVILLE, ON, L0P 1B0, omitted

(21) Appl. No.: 11/653,487

(22) Filed: Jan. 16, 2007

(51) Int. Cl. G10D 13/02

(52) U.S. Cl. 84/422.4

(57) ABSTRACT

A stick type drum stick is disclosed which includes drum stick design featuring a hole drilled longitudinally in the playing striking end. The primary purpose is to accommodate a series multiple rods of reasonable straightness formed around a foam core of the same length. The result of combining these materials in this format produces a multi task drum stick.

### BACKGROUND OF THE INVENTION

1. Field of Invention

The present invention relates to drumsticks and, more particularly, to a unique wooden stick type drumstick with improved percussive characteristics.

2. Description of the Prior Art

In the prior art there have been two types of drumsticks. The brush type which typically produces a sweeping sound and the stick type which produce a much stronger or more percussive sound. In the prior art stick type drumsticks were made of elongated round, generally cylindrical solid wood members that were tapered near one end. This end typically was in the shape of a ball-like head which was used to beat on the drum.

The brush type drumsticks were usually made up of a plurality of metal filaments secured to a handle. One improved embodiment of a brush type drumstick is shown in U.S. Pat. No. 4,200,026. That invention involves the use of a plurality of elongated plastic strands which are arranged in a tight bundle which is fixed at one end as by molding or fusing to form a handle. The plastic strands are free to spread out at the other end to achieve the brush sound when used. That drumstick although an improvement over prior art brush sticks offers only limited use as a percussive stick owing to its basically soft and flexible nature.

In U.S. Pat. No. 4,535,671, that patent provides certain unique playing characteristics suitable for certain applications. By means of this drumstick certain percussive resonance and tonal qualities are met. The drumstick of this invention includes a bundle, substantially straight wooden rods, which are preferably round hardwood rods such as dowels. The bundle is assembled and bound or banded tightly together, as by a rigid plastic tape. In this drumstick design a band is placed at a location relatively close to the playing or beating end. The rods at the handle end of the bundle are also retained tightly together. A sleeve or overlay retainer may then be applied over the drumstick at the opposite end to form the handle. The combination of the binding of the rods as such yields a stick type drumstick, which has specific percussive strength, yet it is slightly flexible so that the combination including the interaction of the wooden rods among themselves when a drum is struck yields its tonal qualities.

A third drum stick design under U.S. Pat. No. 7,084,339 is registered under this applicants name and it is with respect to this patent number that this application and stick design has further enhanced and altered the physical properties and playing characteristics inherent of that particular patent. Although similar in nature it combines a foam core surrounded by multiple rods incorporated in to a traditional drumstick creating a unique multi task drum stick warranting its own need for patent consideration.

### SUMMARY OF THE INVENTION

A stick type drumstick is disclosed comprised of a solid wood shaft, herein after referred to as the shaft. The shaft extends to a position where a hole is drilled in the horizontal plain starting at the end nearest to the striking or beating end. Further, the stick type drumstick includes a head consisting of a plurality of individual rods formed around a foam core, this combination of individual rods and foam core herein after referred to as the head are inserted and glued into the hole of the shaft. An optional cosmetic retainer can be placed over the adjoining areas of the two combined components shaft and head to create a smooth visual transition between the two mediums. An optional movable ‘O’ ring placed around the outside diameter head is adjustable in position. This option alters the bounce response and tonal qualities upon striking the playable surface with the head. The distinguishing features of a foam core in the crown are to provide substantial rebound and bounce and to absorb a significant amount of the impact during playing thus aiding in the protection of the individual rods. The unique features of a foam core provide the percussionist an easier technical approach when playing musical passages at high tempos and low volume levels. A foam core aids in the longevity of the rods by providing an internal cushion to absorb a significant portion of force of impact. The combination of the center foam core and the individual rods combine to create a distinct and unique percussive sound.

The rigid characteristic of the shaft provides a traditional tactile feel of a drumstick. In addition it allows traditional drum stick techniques such as ‘rim shots’ and ‘cross sticking’ to be accomplished within traditional sound expectations. The bell of the cymbal can also be struck aft of the crown area to provide a sound similar to a traditional drum stick. The benefit of incorporating such features of the crown and shaft increases the dynamic range available in one drumstick.

### BRIEF DESCRIPTION OF THE DRAWINGS

In the drawings wherein like numerals are used to depict like parts throughout the same:

FIG. 1 is a side view of the individual rods placed around the outside diameter of the foam core;

FIG. 2 is an enlarged cross-sectional view along line 2A-2A of FIG. 1;

FIG. 3 is a side view depicting the solid wood shaft;

FIG. 4 is a side view depicting a the embodiment of the drumstick of the invention;

FIG. 5 is a side view of another embodiment of the invention using an alternate tapered solid wood shaft;

FIG. 6 is a side view of alternate head or insert material;

FIG. 7 is an enlarged cross-sectional view along line 7A-7A of FIG. 6;

FIG. 8 is a side view of another embodiment of the drumstick of the invention using alternate head or insert material:

### DESCRIPTION OF THE PREFERRED EMBODIMENTS

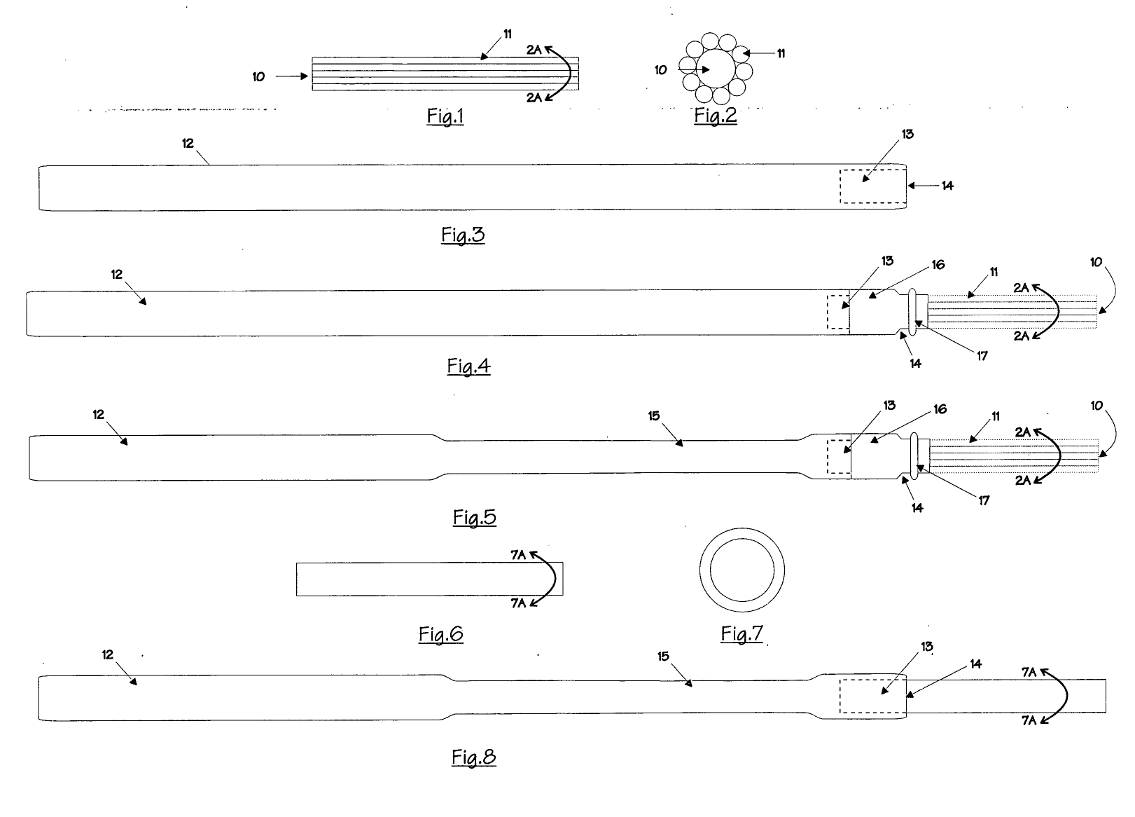

FIG. 1 depicts the foam core 10 with surrounding individual rods 11 which are disposed to form a bundle. The bundle of rods and foam core as depicted in the cross section 2A is glued into the pre-drilled hole 13 at the end 14 of the solid wood shaft 12 depicted in FIG. 3 to form a complete multi task drumstick as depicted in FIG. 4. An overall length of the combined components is approximately 16 inches. It will be appreciated that the individual rods depicted in FIG. 1 and FIG. 2 of the drumstick invention may be fabricated of any suitable wood or synthetic material such as polypropylene, nylon, PVC or ABS plastics which has the required degree of stiffness and resilience desired. Examples of possible woods include birch, oak, maple, ramin and ash or bamboo, although it is contemplated that others will suffice as well. The particular number of rods 10 used may vary with the application and diameter size of rods 10 used in conjunction with the hole size 13 drilled at 14 as depicted in FIG. 4. It has been found, however, that when 10 rods of ⅛ inch diameter are placed around a 5/16 inch round foam core as depicted in FIG. 2, the result produces a very good fit in to a ½ inch diameter pre-drilled hole 13 of the solid wood shaft 12 at 14 as depicted in FIG. 4. The depth of the hole 13 as in FIG. 3 may vary however it has been observed that a hole of 1 inch depth provides a cavity that will firmly secure the foam core and rods. An optional sleeve 16 may overlap the adjoining components to provide a smooth visual transition between the solid wood shaft 12 and the rods and foam core at 14 as depicted in FIG. 4. This may be a material which is heat shrinkable such as a thin polyvinyl chloride (PVC) sleeve or the like. In the above example, a ¾ inch diameter PVC sleeve having a 0.025 inch wall thickness was used. An optional ‘O’ ring 17 placed around the outside diameter of the rods and foam core is adjustable in position as depicted in FIG. 4. This option alters the bounce response and tonal qualities upon striking the head on to a playable surface.

Yet another embodiment is depicted in FIG. 5 in which a solid wood shaft has been shaped and tapered 15 in to an hour glass shape. This shape of handle can be desirable in reducing the overall handle weight and consequently shifting the balance point toward the gripping area of the solid wood shaft as depicted in FIG. 5. This may be a preferred design shape when altering the rod material in FIG. 1 and FIG. 2. Another embodiment of the stick design may be realized by utilizing other materials such as polycarbonate or nylon tubes as depicted in FIG. 6 Inserted and glued in to the pre drilled hole 13 at 14 of the solid wood handle 12 as depicted in FIG. 8. This embodiment of the stick design produces a very responsive rebound, the sound characteristics obtained by combining a wood shaft and an open ended tube are defined by the thickness of the tube wall and hardness of the tube material. The strength of combining the synthetic material at the striking end and the shaft produces a highly durable combination. It has been observed vibrations present in the hollow tube when struck are absorbed by the natural qualities of the solid wood shaft. This combination of materials helps bridge a gap between inherent qualities of synthetics and natural traditional of wood allowing a result that is more user friendly to than that of solid synthetics.

1. A stick type drumstick comprising: a solid wood shaft combined with a head wherein the wood shaft is of a length that is the substantial portion of the length when combined with the head; where the head is comprised of a foam core surrounded by individual rods, said rods in adjacent parallel formation around the said foam core form a round bundle which are inserted and glued securely into a pre drilled hole at the playing or striking end of the said solid wood shaft.

2. The drumstick of claim wherein the solid wood shaft of a straight and consistent diameter from the butt end to the playing end.

3. The solid wood shaft in claim 2 can be in the alternative shape wherein the mid section of the wood shaft has been reduced in diameter, that when the shaft is viewed from a side profile it is of a similar shape to that of an hour glass.

4. The drumstick in CLAIM 1 wherein the said foam core is of a compressible variety.

5. The foam core in claim 4 is 5/16inch in diameter.

6. The drumstick in CLAIM 1 wherein the said individual rods are comprised of natural hardwood material.

7. The number individual rods in CLAIM 6 is 10.

8. The drumstick in CLAIM 1 wherein the said pre drilled hole is of an adequate diameter and depth to secure into position the foam core in claim 5 and individual rods in claim 6.

9. The individual rods of claim 6 wherein the diameter of the said individual rods is 1/8of an inch in diameter size.

10. The drumstick of claim 1 may utilize an optional overlapping cosmetic sleeve comprised a heat shrinkable material.

11. The drumstick of claim 1 may utilize an optional a moveable ‘0’ ring around the outer circumference of the said head.

12. The individual rods in claim 6 wherein the said hardwood is one selected from the group consisting of birch, maple or bamboo.

13. The drumstick of claim 1 wherein the playing or striking end of foam core and individual rods are aligned to form a substantially even surface perpendicular to the longitudinal axis.

14-16. (canceled)
